(19) United States
(12) Patent Application Publication
(10) Pub. No.: US 2005/0145302 A1
(43) Pub. Date: Jul. 7, 2005

(54) Method for producing a magnetic multipole encoder

(76) Inventors: Heinz Mutterer, Baden-Baden (DE); Erdal Kaya, Mannheim (DE)

Correspondence Address: HARNESS, DICKEY & PIERCE, P.L.C., P.O. BOX 828, BLOOMFIELD HILLS, MI, 48303, US

(21) Appl. No.: 11/014,622

(22) Filed: Dec. 16, 2004

(30) Foreign Application Priority Data
Dec. 19, 2003 (DE) 103 60 613.0-24

(51) Int. Cl. H01F 1/03; C21D 1/04

(52) U.S. Cl. 148/108; 148/103

(57) ABSTRACT

A method for producing a magnetic multipole encoder with a carrier and at least one track made from a magnetizable material, in which the track made from magnetizable material is provided with strip-shaped magnetization of alternating polarity via the effect of an externally applied magnetic field. In a first step, the magnetic track is premagnetized with a uniform polarity and, in a second step, the polarity of the premagnetized track is reversed in strip-shaped regions. The method of the invention permits not only the use of simplified magnetization tools, but it can also be carried out faster and affords pole separations of the highest accuracy without additional optimization and adaptation steps.

### CROSS-REFERENCE TO RELATED APPLICATIONS

This application claims the benefit of German Patent Application 103 0 613.0-24, filed Dec. 19, 2003. The disclosure of the above application is incorporated herein by reference.

### FIELD OF THE INVENTION

The invention relates to a method for producing a magnetic multipole encoder with a carrier and at least one track made of a magnetizable material. Te track is made of a magnetizable material that is provided with a strip-shaped magnetization of alternating polarity via the effect of an externally applied magnetic field.

### BACKGROUND OF THE INVENTION

It is known to use so-called multipole encoders for recording the speed of rotation or the angular position of rotating machine parts. For example, for determining the particular, current angular position of a crankshaft of an internal combustion engine or for recording the rotational speed in wheel brake anti-blocking systems.

As a rule, such multipole encoders comprise an essentially ring-shaped carrier body consisting, for example, of a metallic material which, at least on its outer peripheral edge, is provided with at least one magnetic track. The magnetic track can consist, for example, of a thermoplastic material containing interspersed magnetized ferrite.

To the magnetic track is imparted a strip-shaped magnetization with narrowly spaced alternating north and south poles. For the measurement of the angular position, the encoder, as a rule, contains in the strip magnetization a so-called singular spot. For example, the singular spot may be in the form of a widened pole or some other pole arrangement deviating from the strip magnetization. The spot serves as reference site for the determination of the angular position.

For the measurement of the angular position or speed of rotation of a shaft or axle, the magnetic encoder is usually fastened to the shaft or axle. Applications are also known, however, in which the encoder is fastened to a housing that rotates about a stationary shaft or axle. During the rotation of the shaft or axle, or of the housing, a periodically changing magnetic field that depends on the spacing of the magnetic poles is generated. It is then possible to detect the magnetic field by means of a magnetic sensor. The sensor may be, for example, a Hall sensor or a magnetoresistive sensor, also known as a MR sensor or GMR (giant MR) sensor, which converts the temporally changing magnetic field into a periodic electric signal which, as described above, can be used for motor control.

The magnetization of the magnetic track is accomplished by the action of an external magnetic field on the magnetizable material. To this end, the magnetization can be carried out statically as well as dynamically. The static magnetization method involves the use of a magnetization tool consisting, for example, of a carrier with electric conductors incorporated into the surface which upon exposure to current impulses can produce magnetic fields. The tool is disposed opposite the track to be magnetized. In this case, the magnetization tool has a number of poles or pole arrangements that correspond to the number to be imparted. The magnetization of the magnetic track occurs by the action of the magnetic fields of the magnetization tool on the magnetic material in the track. North and south poles are imparted simultaneously. In a dynamic variant of the method, the magnetic track is led past a magnetizing magnetic head that generates a magnetic field variable in accordance with the desired number of poles and pole arrangements. By this procedure, the magnetic poles are imparted to the magnetic track successively, one after the other. The drawback of the known methods is that the neighboring poles of opposite magnetization affect each other during the application of the magnetization so that they can alter the geometry of the pole arrangement. During the closing of a strip-shaped magnetization imparted to a ring-shaped track, in particular, the problem usually arises that the last-magnetized pole influences the first-magnetized pole so that the accuracy of the signal is reduced at this spot. Expensive simulation and optimization steps are therefore needed to achieve the required accuracy of pole separation.

### SUMMARY PRESENTATION OF THE INVENTION

The object of the invention is to provide a method for producing a magnetic multipole encoder that can be carried out in simple and economical manner, and that affords magnetic strip patterns of the highest accuracy.

According to the invention, in a method for producing a magnetic multipole encoder with a carrier and at least one track that consists of a magnetizable material, the track of magnetizable material is provided with a strip-shaped magnetization of alternating polarity by the action of an externally applied magnetic field. In a first step, the magnetic strip is premagnetized with a uniform polarity and, in a second step, the polarity of the premagnetized track is reversed in strip-shaped regions to give the opposite polarity. Surprisingly, the method of the invention does not exhibit the problem of neighboring poles influencing each other as do the known methods. As a result of the symmetrical conditions created by uniform polarization, the entire system is so stable that mutual effects on the polarity are avoided to the highest degree. This provides the special advantage that the above-said closing problem is eliminated.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic representation of the steps of the static procedure of the method of the invention for producing a symmetrical strip pattern;

FIG. 2 is a schematic representation of the steps of the dynamic procedure of the method of the invention for producing a symmetrical strip pattern; and

FIG. 3 is a schematic representation of the steps of the dynamic procedure of the method of the invention for producing an asymmetric strip pattern.

### DETAILED DESCRIPTION OF THE PREFERRED EMBODIMENTS

The following description of the preferred embodiment(s) is merely exemplary in nature and is in no way intended to limit the invention, its application, or uses.

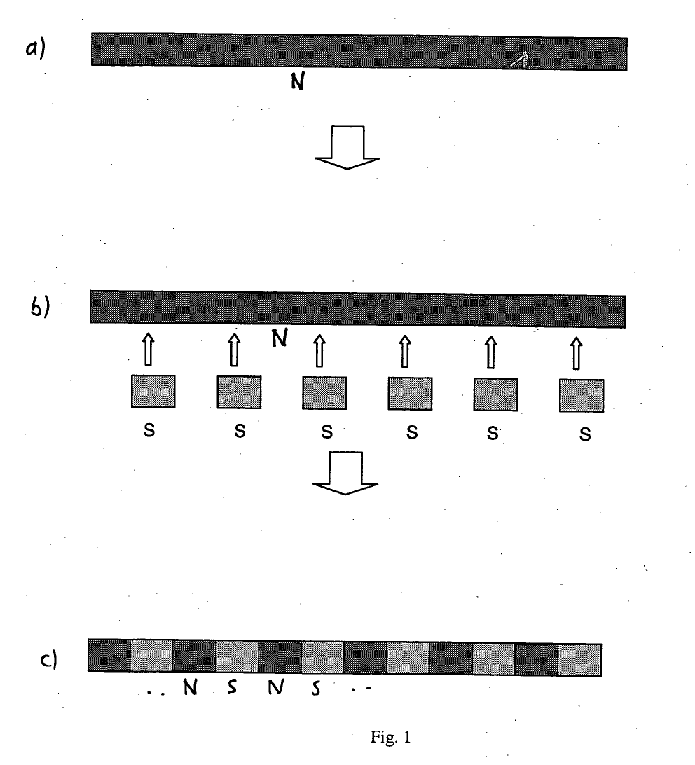

In FIG. 1 is shown, without intending to limit the general applicability of the invention, a linearly disposed magnetic track of a multipole encoder which in a first step a) of the method has been premagnetized over the entire length of the surface with a uniform polarity, here the north pole. For greater clarity, the carrier body is not shown. Similarly, here and in the following, the preparation of the carrier body and the application of the magnetic track onto the carrier body, as well as possible materials of construction for the carrier body and the magnetic track, will not be discussed. These methods and materials have been repeatedly described in the prior art and in the patent literature. The premagnetization here, as well as in the method described hereinbelow, can be accomplished in the simplest case by means of a permanent magnet which is disposed opposite, or is guided along, the track to be magnetized. In the next step b), the opposite poles are imparted over this large pole covering the entire strip by means of a magnetization tool disposed opposite the magnetic track in a manner such that a strip magnetization with opposite polarity is created. In view of the fact that, as a result of pre-magnetization, every other pole is already present, a static magnetization tool requires only one half of the number of poles for applying the opposing field onto the premagnetized encoder track. This results in a substantially simpler tool, because as a result of the halved number of poles, the pole distances are doubled. FIG. 1c shows the finished magnetic track of the encoder with a symmetrical strip magnetization of alternating polarity.

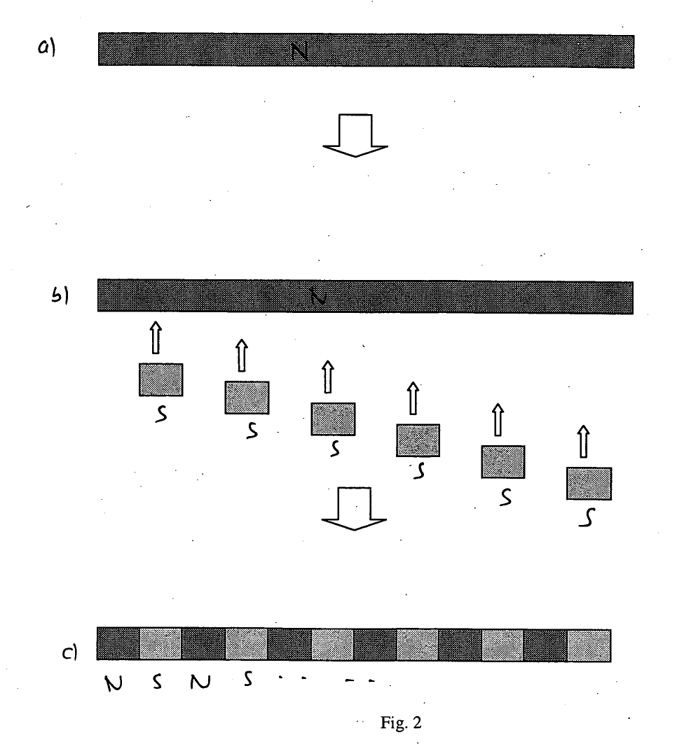

In the magnetization method represented in FIG. 2, the premagnetization a) described hereinabove is followed by overmagnetization b) with the opposing poles by means of a dynamic method. In this case, after the magnetization of each pole, the track to be magnetized is moved further over a distance equal to the width of the already existing pole, so that in this case, too, the tool must apply only one half the number of poles. For dynamic magnetization, this also leads to shorter operating times, for example, also as a result of the fact that the magnetic heads do not heat up as much. Here, too, the result of the magnetization process is a magnetic encoder track provided with strip magnetization of alternating polarity, as shown in c).

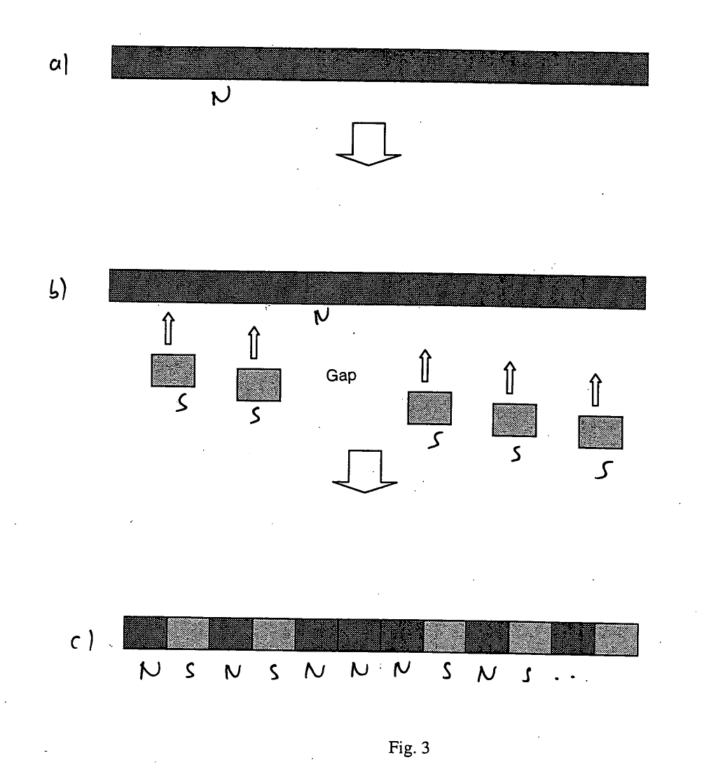

For completeness, FIG. 3 shows the use of a dynamic method similar to that described in FIG. 2 wherein, as under c), it can be seen that asymmetry is created in the form of a singular spot in the strip magnetization. In the practical example shown, without intending to limit the general applicability of the invention, the singular spot consists of a north pole widened by two strips. Other geometric arrangements for creating a singular spot are also possible. Also possible is the creation of a strip magnetization with a singular spot by use of the above-described static method, wherein the magnetization tool must be correspondingly designed. The singular spot can be used as reference spot for, for example, angular position measurement.

Although the method of the invention is described in the foregoing essentially from the standpoint of applications in the automotive field, it is obvious that the method can be used for producing magnetic encoders in any other application fields. For example, the method of the present invention may also be used for consumer electronics. The present invention is by no means limited to automotive uses of an encoder.

The description of the invention is merely exemplary in nature and, thus, variations that do not depart from the gist of the invention are intended to be within the scope of the invention. Such variations are not to be regarded as a departure from the spirit and scope of the invention.

1. A method for producing a magnetic multipole encoder with a carrier and at least one track made from a magnetizable material, in which the track made from magnetizable material is provided with strip-shaped magnetization with alternating polarity via the effect of an externally applied magnetic field, comprising:
a first step of pre-magnetizing the magnetic track with a uniform polarity; and
a second step of reversing the polarity of the premagnetized track in strip-shaped regions.

2. The method according to claim 1, wherein the magnetization is carried out using a magnetizing tool that is arranged statically relative to the track to be magnetized.

3. The method according to claim 1, wherein the magnetization is carried out dynamically using a magnetizing head, the magnetic track and the magnetizing head being moved relative to each other.

4. The method according to claim 1, wherein the premagnetization is carried out using a permanent magnet.
